(19) United States
(12) Patent Application Publication
(10) Pub. No.: US 2018/0205627 A1
(43) Pub. Date: Jul. 19, 2018

(54) CALCULATING PERCENTAGE SERVICE CONTRIBUTION IN A SERVICE CALL TREE

(71) Applicant: Microsoft Technology Licensing, LLC, Redmond, WA (US)

(72) Inventors: Toon Sripatanaskul, Menlo Park, CA (US); Thomas Goetze, Danville, CA (US); Ritesh Maheshwari, Mountain View, CA (US); David He, Cupertino, CA (US); Ruixuan Hou, Sunnyvale, CA (US)

(21) Appl. No.: 14/987,582

(22) Filed: Jan. 4, 2016

(51) Int. Cl. H04L 12/26; H04L 29/08

(52) U.S. Cl. CPC H04L 43/0876; H04L 43/106; H04L 67/16

(57) ABSTRACT

Techniques are provided for automatically accounting and apportioning of observed service execution times. In an embodiment, the computers determine a total amount of time to process a request. The computers determine which services are called in order to process the request. The called services include a first service and a second service. The computers determine a first amount of time that the first service spends in response to processing the request and a second amount of time that the second service spends in response to processing the request. The computers calculate a first percentage for the first service based on the first amount of time and the total amount of time and a second percentage for the second service based on the second amount of time and the total amount of time.

### CROSS REFERENCE TO RELATED CASES

This application is related to U.S. application Ser. Nos. 14/611,847, 14/611,869, 14/611,885, and 14/611,918, each of which was filed on Feb. 2, 2015 and is incorporated by reference as if fully described herein.

### FIELD OF THE DISCLOSURE

The present disclosure relates to call trace performance profiling. Techniques for accounting and apportionment of observed service execution time are presented.

### BACKGROUND

Some high traffic web sites serve millions of page views a minute. A single page view request may result in many calls to downstream services that span multiple backend tiers. Though web applications depend on downstream services, application developers typically have no insight on the relationships and performance of those services. This lack of insight poses a number of major challenges, such as performance optimization and root cause analysis.

For example, not all optimizations are likely to boost end-to-end latency. Furthermore, concurrency of subtasks during the execution of a request may wrongly bias or otherwise distort the actual costs of the subtasks or other involved tasks. Such a distortion may hinder proper identification or resolution of a performance bottleneck.

### BRIEF DESCRIPTION OF THE DRAWINGS

In the drawings:

FIG. 1 is a block diagram that depicts an example computer system that calculates latency contributions of nested service calls, in an embodiment;

FIG. 2 is a flow diagram that depicts an example process for calculating latency contributions of nested service calls, in an embodiment;

FIG. 3 is a block diagram that depicts an example computer system that apportions latency contributions of collaborating service calls, in an embodiment;

FIG. 4 is a flow diagram that depicts an example process for apportioning latency contributions of collaborating service calls, in an embodiment;

FIG. 5 is a block diagram that depicts an example computer system that apportions latency contributions of collaborating service calls, in an embodiment;

FIG. 6 is a flow diagram that depicts an example process for apportioning latency contributions of collaborating service calls, in an embodiment;

FIG. 7 is a block diagram that depicts an example computer system that equally apportions latency contributions of collaborating service calls, in an embodiment;

FIG. 8 is a block diagram that depicts an example computer system that apportions latency contributions of collaborating service calls, in an embodiment;

FIG. 9 is a block diagram that depicts an example computer system that isolates a request trace, in an embodiment;

FIG. 10 is a block diagram that depicts an example computer system that identifies a critical path, in an embodiment;

FIG. 11 is a block diagram that depicts an example computer system that simulates a request trace, in an embodiment;

FIG. 12 is a flow diagram that depicts an example process for simulating a request trace, in an embodiment;

FIG. 13 is a block diagram that depicts an example computer system that averages traces, in an embodiment;

FIG. 14 is a flow diagram that depicts an example process for averaging traces, in an embodiment;

FIG. 15 is a block diagram that depicts an example computer system that apportions latency contributions of browser subtasks, in an embodiment;

FIG. 16 is a block diagram that illustrates an example computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Techniques are provided for automatically calculating service contributions to total latency in a service call tree.

In one technique one or more computers determine a parent amount of time that a parent service takes to respond to a call to the parent service. The computers determine that, in response to the call, the parent service makes subsequent calls to other services. For each service subsequently called, the computers determine a child amount of time that the parent service waits to respond to one of the subsequent calls. The computers calculate a latency of the parent service based on the parent amount of time and the child amount of time that are associated with each of the subsequently-called services.

In one technique, the computers determine a total amount of time to process a request. The computers determine which services are called in order to process the request. The called services include a first service and a second service. The computers determine a first amount of time that the first service spends as part of processing the request and a second amount of time that the second service spends as part of processing the request. The computers calculate a first percentage for the first service based on the first amount of time and the total amount of time and a second percentage for the second service based on the second amount of time and the total amount of time.

In an embodiment, the computers store timestamp data that indicates, for each of multiple calls made during processing of a particular request, at least two of: a duration, a starting timestamp, and an ending timestamp. Based on the timestamp data associated with a first call, the computers identify a first time period for the first call. Based on the timestamp data associated with a second call, the computers identify a second time period for the second call. The computers determine that the first time period overlaps the second time period. The computers calculate a first amount of processing for the first call and a second amount of processing for the second call. Both of the first and second amounts are based on the overlap amount.

### Example Computer System

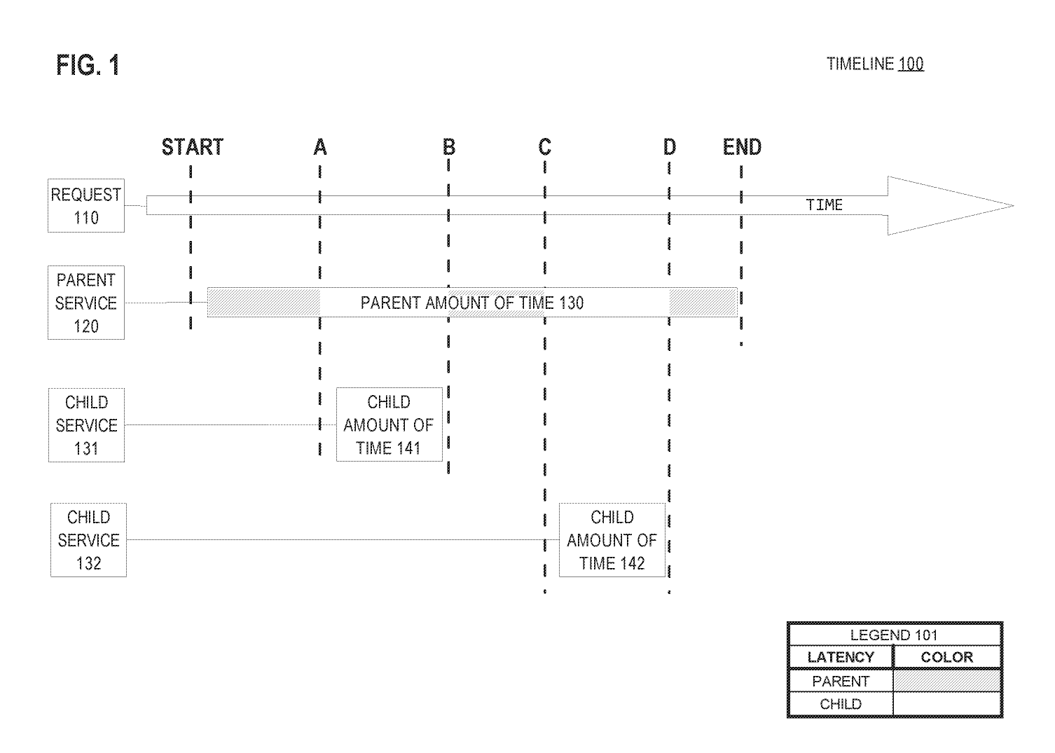

FIG. 1 is a block diagram that depicts example timeline 100 as an observed schedule of executed service calls, in an embodiment. A computer may analyze the elements of timeline 100 to calculate latency contributions of nested service calls, in an embodiment.

Timeline 100 shows time spent by one or more computers during execution of request 110. The computers that execute request 110 may or may not include the computer that later analyzes timeline 100 after request 110 is finished. For example, request 110 may be executed by a computer cluster, the details of timeline 100 archived as a call graph, and days later these details are analyzed by a different cluster or a laptop.

Request 110 may be a hypertext transfer protocol (HTTP) request, a query such as a database query, a resource retrieval request such as a retrieval of an online object, a dispatch of a message, a service invocation, a subroutine call, a dispatch or interpretation of a command, a program execution, or other coarse-grained unit of computer processing. Request 110 may be in-process (such as a method call), machine-local (such as a Unix process signal), or remote (such as a representational state transfer (REST) message over a network).

The horizontal arrow indicates the passage of time from left to right. The dashed vertical lines indicate points in time during the execution of request 110. Execution of request 110 begins at time START and finishes at time END.

In this example, the execution of request 110 begins by calling parent service 120. Parent service 120 may have an implementation that is fine-grained (such as a method), medium-grained (such as a library entry point), or coarse-grained (such as another request more or less like request 110).

For example, request 110 may be a message that is mediated by a message-oriented middleware (MOM) architecture such as java message service (JMS). Parent service 120 may be a top-level message handler, such as a message loop, to which request 110 may be initially dispatched.

Executing parent service 120 spans a particular time period, shown as parent amount of time 130. In this example, a parent amount of time 130 extends from time START to time END, as does the execution of request 110, because parent service 120 fully executes the entirety of request 110 from beginning to finish.

Although only one parent service is shown, request 110 may directly trigger the execution of multiple top-level services, perhaps in parallel. For example, request 110 may be a request to a computer cluster, such as a Hadoop command that is distributed to a cluster of mappers.

During its execution, a parent service 120 may invoke other services, such as child services 131-132. Each of child services 131-132 may be in-process, machine-local, or remote to parent service 120.

Each of child services 131-132 may have an implementation of finer or coarser granularity than parent service 120. If horizontal scaling such as bulk synchronous parallelism (BSP) or other data parallelism is involved, then child services 131-132 may share the same implementation. If recursion is involved, then parent service 120 and child service 131 and/or 132 may share the same implementation.

Parent amount of time 130 may be subdivided into phases as follows. Between time START and time A, parent service 120 executes without calling any child services. This segment is colored gray. According to legend 101, gray indicates time spent by parent service 120 for its own processing. This is referred to herein as “self-latency.”

The segment of parent amount of time 130 between time A and time B is colored white, which indicates time spent when parent service 120 invokes child service 131. The call to child service 131 may be synchronous (parent service 120 stalls until child service 131 finishes) or asynchronous (parent service 120 continues executing concurrently relative to the execution of child service 131).

As a synchronous example, parent service 120 may invoke child service 131 directly on a call stack. As another synchronous example, parent service 120 may invoke child service 131 via an HTTP request and wait for an HTTP response when child service 131 finishes.

As an asynchronous example, parent service 120 may spawn an execution thread for child service 131 and continue processing without waiting for child service 131 to finish. As another asynchronous example, parent service 120 may send a signal or queue a message that invokes child service 131. Asynchronous calling may be fire-and-forget or gathered perhaps by a semaphore, barrier, or future.

Later in the execution of request 110, parent service 120 also invokes child service 132, perhaps imposing child amount of time 142 as additional latency that may extend parent amount of time 130. Although child amounts of time 141-142 as shown do not overlap, in another example they may partially or exactly overlap.

Although not shown, each of child services 131-132 may call other child services. As such, a call graph (usually a tree) may be complex.

Timestamp measurements may be made by a computer that invokes a service or a computer that provides the service. Some or all of services 120 and 131-132 may execute on a same computer or separate computers.

The computers that execute request 110 and services 120 and 131-132 may log amounts of time 130 and 141-142, perhaps with each as some combination of timestamps and/or a duration. For example, amounts of time 130 and 141-142 may be recorded as entries in log files. These log files may later be data-mined to construct a call graph, populate a history database, or perform analytics.

For example, a computer may record or enhance the history of requests and calls in a way that includes an accounting of various durations to individual calls. Such accounting may be used for performance profiling or monetary cost accounting.

For example, a call graph that is colored according to such time accounting may be used to isolate an I/O bottleneck or a hotspot (compute bottleneck) somewhat like using a heat map. Isolating a hotspot may be a step toward alleviating it, thereby saving electricity, cooling, and processor time.

In an embodiment, all of the time spent executing request 110 is accounted solely to parent service 120.

In an embodiment, each of amounts of time 130 and 141-142 is accounted to its respective service 120, 131, or 132. Such accounting may occur regardless of whether the arithmetic sum of amounts of time 130 and 141-142 exceeds the duration of the interval spanning from time START to time END, such as shown. For example, each white segment of parent amount of time 130 is doubly accounted to parent service 120 and either of child services 131-132.

In a preferred embodiment, child amounts of time 141-142 are deducted from parent amount of time 130 when accounting for parent service 120. As such, only the gray segments of parent amount of time 130 are accounted to parent service 120.

### Example Latency Contribution Calculation Process

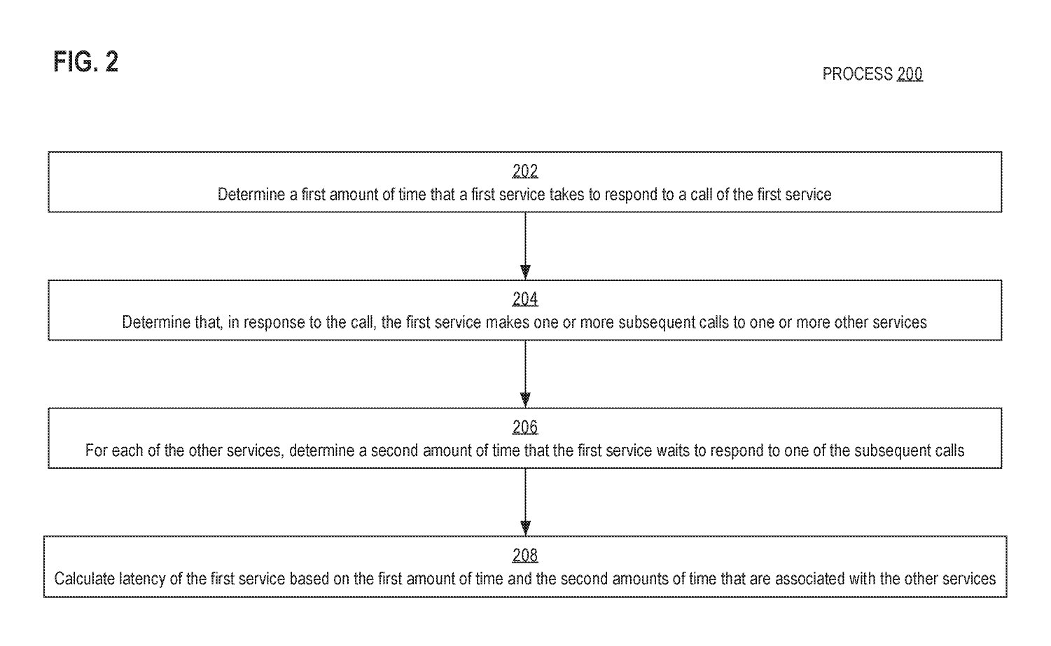

FIG. 2 is a flowchart that depicts example process 200 for automatically calculating the latency contributions of nested calls. Process 200 is discussed with reference to timeline 100.

In step 202, a first amount of time that a first service takes to fully respond is determined. For example, dispatch of request 110 may call parent service 120. Parent service 120 does not finish until parent amount of time 130 elapses. Instrumentation to record timestamps related to parent amount of time 130 may be embedded directly within parent service 120 or within a container of parent service 120, such as an application server.

In step 204, one or more subsequent calls that the first service makes to one or more other services (in response to being called) is determined. For example, execution tracing instrumentation, call graph analysis, or identifier-based correlation of log entries may determine that request 110 is executed by parent service 120, which invokes child services 131-132.

Timestamps for execution of child services 131-132 are recorded, perhaps with a correlation identifier. A correlation identifier may be composed of other identifiers.

In an embodiment, when parent service 120 calls a child service 131, then either or both of services 120 and 131 create (and perhaps logs or otherwise records) trace data that includes at least one of: a service identifier, a timestamp, a page key, a transaction identifier, or a trace identifier. Any of these data may be all or part of a correlation identifier that is timestamped in a log or database.

A service identifier may uniquely identify the service that creates the trace data and/or the service that called it. A page key may identify a web application that submitted request 110. A trace identifier distinguishes a graph, tree, or chain of execution. A trace identifier may instead distinguish one fragment of a call graph from another fragment of the same graph.

In step 206, for each of the other services, a second amount of time is determined for the execution time of one of the subsequent calls is determined. For example, during or long after execution of request 110, log analysis or a timer may reveal that parent service 120 waits for each of child services 131-132 for respective child amounts of time 141-142. The results of step 206 may be analyzed immediately or archived for later.

In step 208, latency of the first service is calculated based on the first and second amounts of time that are associated with each of the other services. For example, an accounting for parent service 120 may deduct child amounts of time 141-142 from parent amount of time 130.

### Example Latency Percentage Calculation System

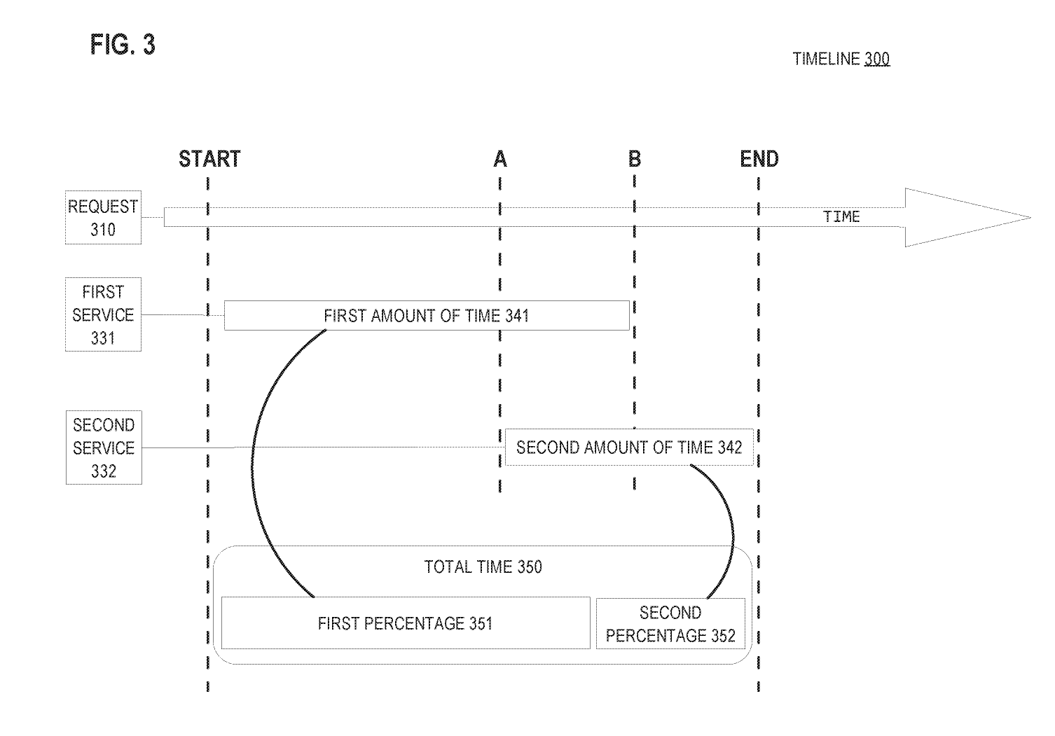

FIG. 3 is a block diagram that depicts example timeline 300 as an observed schedule of executed service calls, in an embodiment. A computer may analyze the elements of timeline 300 to apportion latency contributions of collaborating service calls, in an embodiment.

Timeline 300 shows time spent by services 331-332 during execution of request 310. Services 331-332 may be sibling children that are called during an execution of a same parent service, although not shown. The parent service may or may not be directly called by request 310.

As shown, services 331-332 may be called at different times (time START and time A) and finish at different times (time B and time END). Services 331-332 execute for respective amounts of time 341-342.

Amounts of time 341-342 may partially overlap as shown, exactly overlap, or not overlap. Total time 350 may be an observed wall-clock period needed to execute both of services 331-332.

However, in this example, amounts of time 341-342 overlap. As such, an arithmetic sum of the durations of amounts of time 341-342 exceeds the duration of total time 350. This excess may distort the accounting of the execution of request 310 and the service calls it makes.

For example as shown, the period between time A and time B would be doubly accounted. This can also distort the relative amounts of time spent executing services 331-332, especially if other services not shown are also involved with executing request 310.

Percentages 351-352 indicate the percentage of total time 350 spent respectively executing services 331-332. For example if such over-accounting occurs, then percentages 351-352 would sum to more than 100%, which is erroneous.

To avoid over-accounting, amounts of time 341-342 may be systematically reduced. Such a reduction in this example is applied only to the portion of amounts of time 341-342 that overlap, shown as the period for time A to time B.

Each of amounts of time 341-342 is reduced by some fraction of the duration of overlap. In an embodiment, each of amounts of time 341-342 is reduced by an equal fraction of the duration of overlap. In this example, the overlap duration may be split in half (between two services 331-332) and each half accounted to each of services 331-332. In another embodiment, each of amounts of time 341-342 is reduced by a weighted and different fraction of the duration of overlap.

By apportioning the overlap period between both of services 331-332, percentages 351-352 may be calculated as fractions of total time 350 that sum to 100%. Such overlap may naturally occur when at least one of services 331-332 is invoked asynchronously.

### Example Latency Percentage Calculation Process

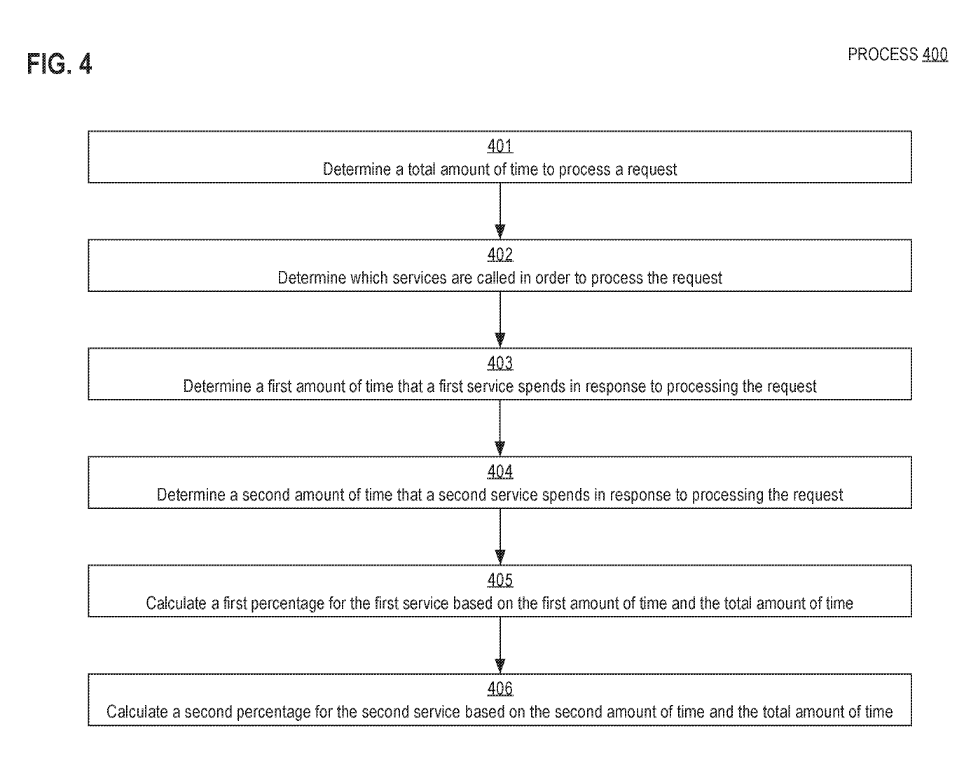

FIG. 4 is a flowchart that depicts example process 400 for automatically calculating the latency percentages of collaborating calls. Process 400 is discussed with reference to timeline 300.

In step 401, a total amount of time to process a request is determined. For example, a computer logs the beginning and ending timestamps of the execution of request 310 and the calls it makes.

In an embodiment, the computer determines time START by identifying the earliest timestamp for when each amounts of time 341-342 began. In an embodiment, the computer determines time END by identifying the earliest timestamp for when each amounts of time 341-342 ended.

In step 402, which services are called in order to process the request are determined. For example, a computer determines which parent service or request 310 called child services 331-332. In embodiments, a live call graph is created or a historical call graph is retrieved to assist with the determination of which services were called for request 310.

In steps 403-404, an amount of time that each of two services spends in response to processing the request is determined. For example, a computer measures or retrieves amounts of time 341-342.

In step 405-406, a percentage for each of the two services, based on the total execution time of the request and both amounts of time, is calculated. For example, a computer measures or retrieves first amount of time 341. In an embodiment, the computer apportions the overlap period between both of services 331-332 to derive adjusted amounts from amounts of time 341-342 and then calculates percentages 351-352 based on total time 350 and the adjusted amounts.

### Example Latency Apportionment System

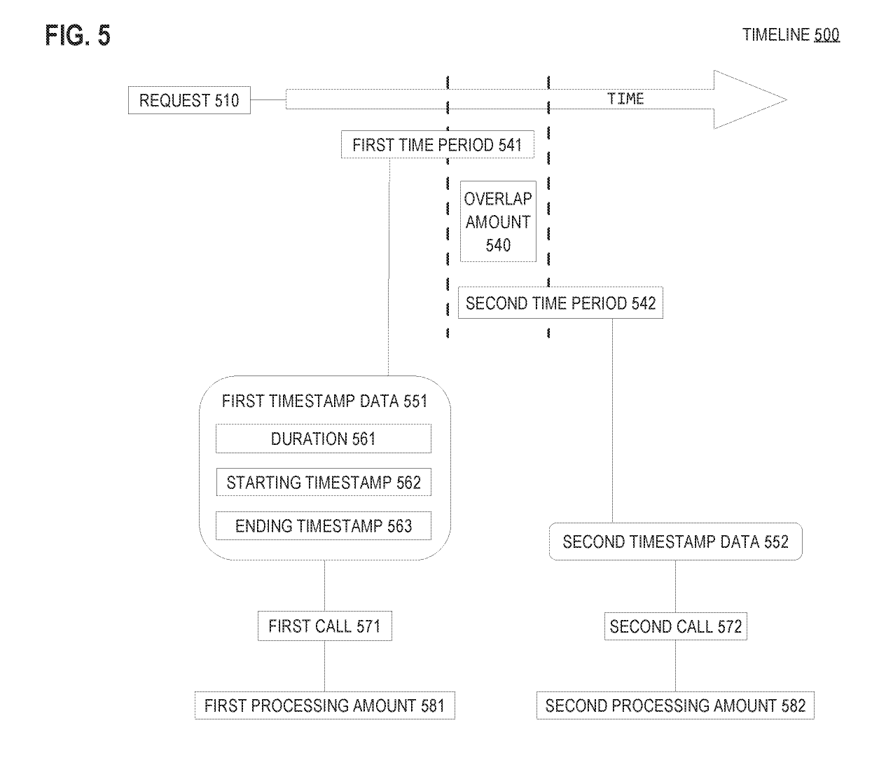

FIG. 5 is a block diagram that depicts example timeline 500 as an observed schedule of executed service calls, in an embodiment. A computer may analyze the elements of timeline 500 to apportion latency contributions of collaborating service calls, in an embodiment.

Timeline 500 shows time spent by calls 571-572 during execution of request 510. Calls 571-572 may be sibling children that are called during an execution of a same parent call, although not shown. The parent call may or may not be directly called by request 510.

Calls 571-572 may be concurrent. Calls 571-572 respectively execute during periods 541-542. Periods 541-542 completely or partially overlap by overlap amount 540.

Periods 541-542 are encoded as timestamp data 551-552. First timestamp data 551 includes at least two of: duration 561, and timestamps 562-563. Although not shown, second timestamp data 552 has similar fields.

Overlap amount 540 may be doubly accounted to calls 571-572. Over-accounting is avoided by apportioning overlap amount between periods 541-542.

Such apportioning may result in derived processing amounts 581-582. Processing amounts 581-582 may be used for billing or performance profiling of calls 571-572, such as calculating relative execution times of calls 571-572 as percentages of total execution time.

### Example Latency Apportionment Calculation Process

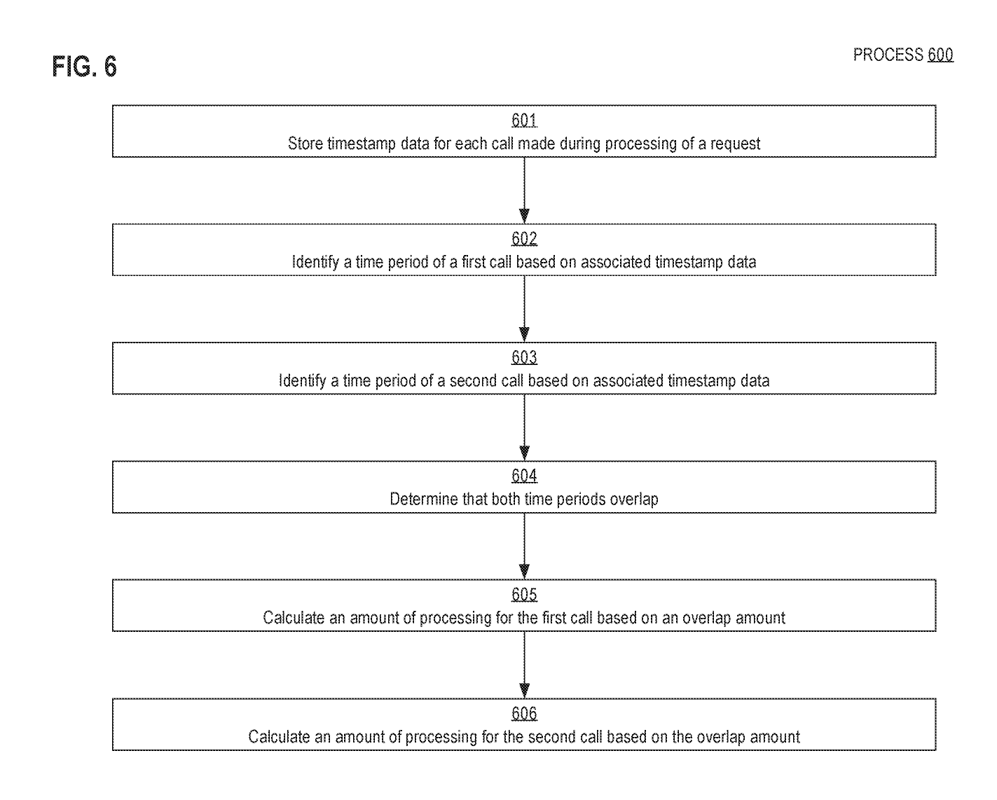

FIG. 6 is a flowchart that depicts example process 600 for automatically apportioning the overlapping latency of collaborating calls. Process 600 is discussed with reference to timeline 500.

In step 601, timestamp data for each call made during processing a request is stored. For example, a computer creates or receives timestamp data 551-552 and then stores them in memory or persistent storage, such as a magnetic disk. For example, timestamp data 551-552 are written to a log or database.

In steps 602-603, the time period of each of two calls is identified based on associated timestamp data. For example, the same or another computer processes timestamp data 551-552 to determine time periods 541-542.

In step 604, an overlap between both time periods is detected. For example, a computer uses timestamp data 551-552 to calculate overlap amount 540.

In steps 605-606, amounts of processing for both calls are calculated based on the overlap amount. For example, a computer apportions overlap amount 540 between time periods 541-542. Based on this apportionment, the computer subtracts the apportioned overlap portions from time periods 541-542 to calculate processing amounts 581-582.

### Equal Apportionment

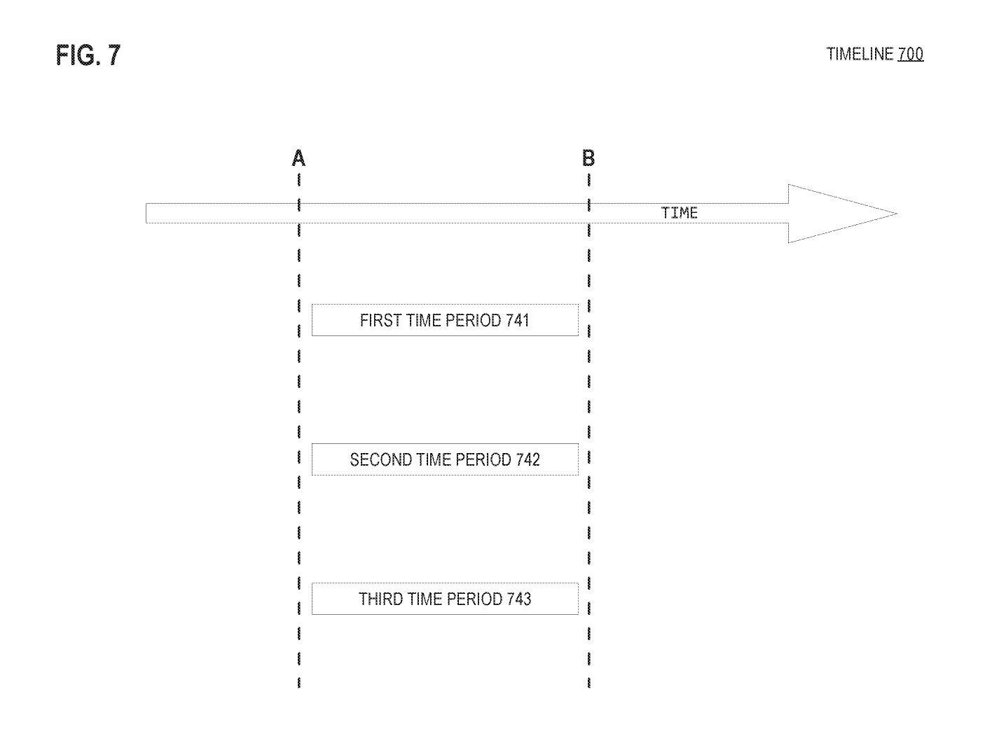

FIG. 7 is a block diagram that depicts example timeline 700 as an observed schedule of executed service calls, in an embodiment. A computer may analyze the elements of timeline 700 to equally apportion latency contributions of collaborating service calls, in an embodiment.

Timeline 700 shows time periods 741-743 spent by calls during execution of a root request or parent call. These calls may be sibling children that are called during an execution of a same parent call, although not shown.

A computer may detect the time periods 741-743 overlap more or less exactly. For example, the computer may compare beginning timestamps to detect that time periods 741-743 begin together at roughly the same time (time A), perhaps within some tolerance threshold of minor variation. Likewise, the computer may compare ending timestamps to detect that time periods 741-743 end together at roughly the same time (time B). In an embodiment, records of the sibling children calls are annotated as being exactly overlapped.

Having detected exact overlap by detecting that time periods 741-743 are (or almost) identical, the computer may equally apportion amongst all three child calls the duration between time A and time B. For example, the computer accounts one third of that duration to each of the three calls.

Equal apportionment may be appropriate for symmetric multiprocessing (SMP) or other data parallelism, such as bulk synchronous parallelism (BSP).

### Implications of Overlap (Parallelism)

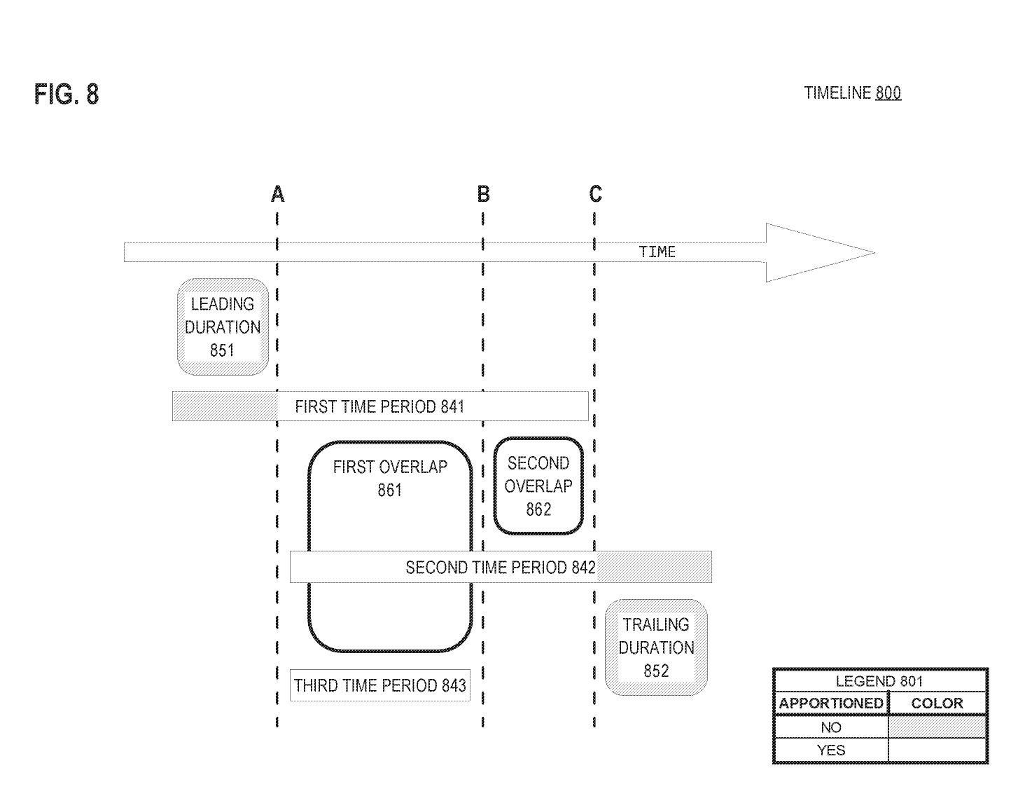

FIG. 8 is a block diagram that depicts example timeline 800 as an observed schedule of executed service calls, in an embodiment. A computer may analyze the elements of timeline 800 to apportion latency contributions of collaborating service calls, in an embodiment.

Timeline 800 shows time periods 841-843 spent by calls during execution of a root request or parent call. These calls may be sibling children that are called during an execution of a same parent call, although not shown.

Durations 851-852 involve no overlapping execution and so are not apportioned. Durations not apportioned are colored gray, per legend 801.

Apportioned durations are colored white. However, over or under accounting may result by an apportionment that is uniform and continuous for the entire duration of overlapping executions between time A and time C.

Such distorted accounting occurs because the degree of parallelism changes during the entire overlap. This is because the entire overlap between time A and time C is actually a concatenation of adjacent overlaps 861-862, which have different degrees of parallelism.

First overlap 861 touches three parallel time periods 841-843. Whereas, second overlap 862 touches only two parallel time periods 841-842.

As such, first overlap 861 may be apportioned three ways (likely equal thirds) to time periods 841-843. Whereas, second overlap 862 may be apportioned only two ways (likely equal halves) to time periods 841-842.

Another factor may need consideration in addition to apportionment. If timeline 800 is used for performance profiling, then a software developer may choose to optimize (e.g. tune or revise) an implementation of any of the three calls that respectively correspond to time periods 841-843.

How beneficial is such optimization depends on which call the developer chooses to optimize. Amdahl's Law implies that optimization of serial logic may achieve greater speedup than optimization of parallel logic.

For example, the gray segments are serial, and the white segments are parallel (i.e., overlapping). Third time period 843 has no gray segment. Consequently, optimization of third time period 843 is unlikely to accelerate the wall-clock execution time of the three calls as a whole. Instead, optimization of whichever of gray durations 851-852 is longer may be likely to provide the greatest boost to overall throughput.

### Trace Isolation

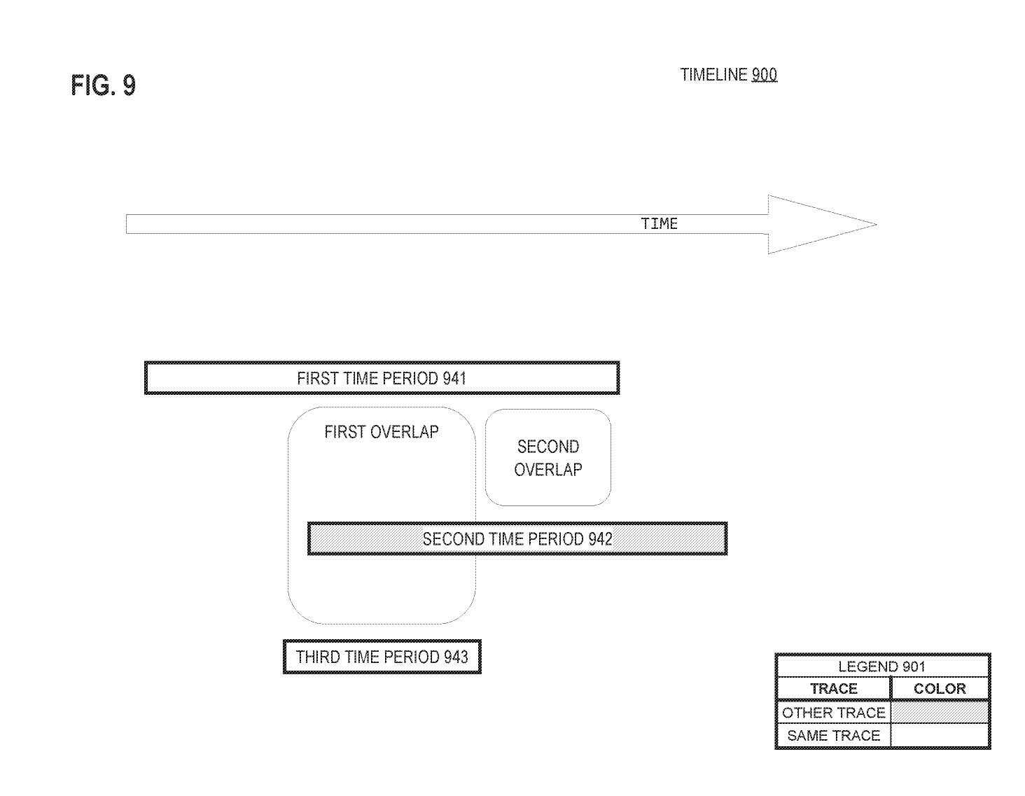

FIG. 9 is a block diagram that depicts example timeline 900 as an observed schedule of executed service calls, in an embodiment. A computer may analyze the elements of timeline 900 to apportion latency contributions of collaborating service calls, in an embodiment.

Timeline 900 shows time periods 941-943 spent by calls during execution of a root request or parent call. These calls may be sibling children that are called during an execution of a same parent call, although not shown.

Especially when data mining historic call graphs or otherwise sifting through timestamp data of past calls, the timestamp data of a particular request execution trace may need analysis in isolation without noisy data of unrelated requests. Likewise, a subgraph for part of a trace may be isolated from data of the rest of a graph.

Such trace isolation may be achieved by accompanying the timestamp data with a trace-related identifier when the timestamp data is created. In an embodiment, trace isolation is unneeded because the service call execution for a trace occurs within its own virtual machine (VM).

Timestamps for time periods 941-943 are recorded, perhaps with such a correlation identifier. A correlation identifier may be composed of other identifiers.

In an embodiment, when child service 941 executes, then either or both of child service 941 and its parent create (and perhaps logs or otherwise records) trace data that includes at least one of: a service identifier, a page key, a transaction identifier, or a trace identifier. Any of these data may be all or part of a correlation identifier that is in a log or database.

For example, time periods 941 and 943 may be for sibling calls within the same particular trace. Whereas, time period 942 is not within that trace.

However, and perhaps because all three time periods 941-943 are contemporaneous (overlapping), their timestamp data may be comingled either in memory or on disk. In that case, including a correlation identifier within the timestamp data may achieve trace isolation.

### Critical Path

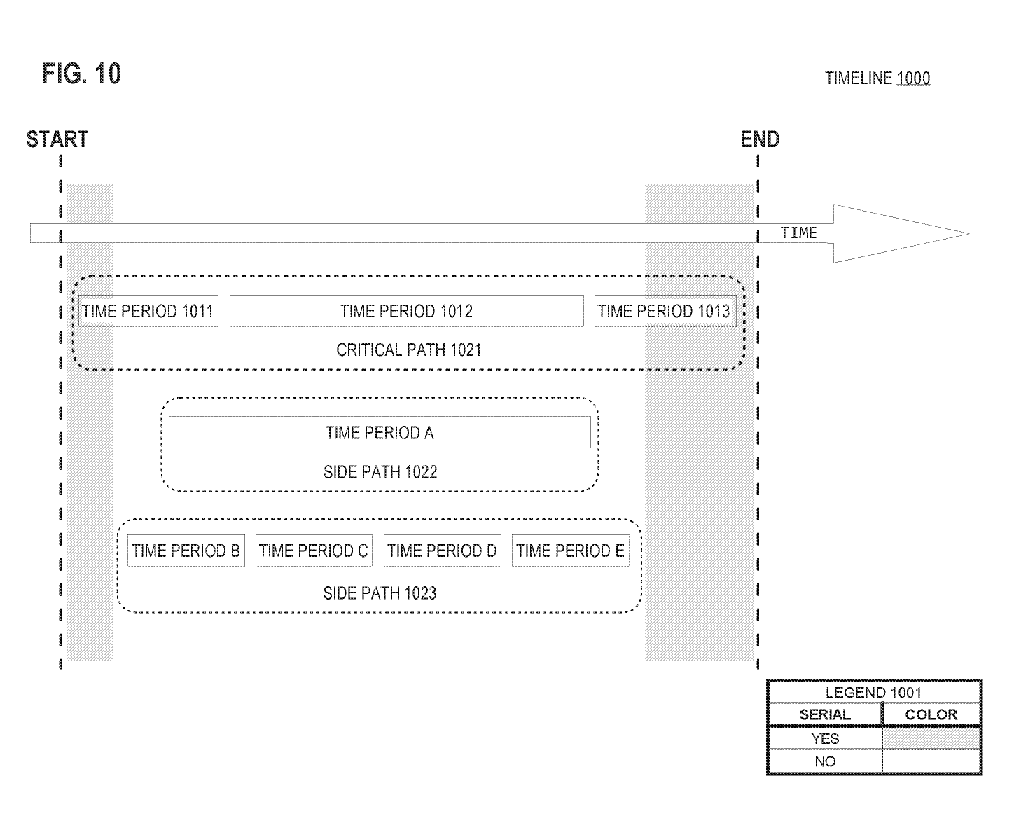

FIG. 10 is a block diagram that depicts example timeline 1000 as an observed schedule of executed service calls, in an embodiment. A computer may analyze the elements of timeline 1000 to apportion latency contributions of collaborating service calls, in an embodiment.

Timeline 1000 shows time periods 1011-1013 and A-E spent by calls during execution of a root request or parent call. These calls may be sibling children that are called during an execution of a same parent call, although not shown.

These calls may be logically grouped into paths 1020-1022. For example, each path may be a branch of a call tree. Likewise, each path may have its own execution container, such as an execution thread, operating system (OS) process, central processing unit (CPU), CPU core, or computer.

A software developer may choose to optimize the service implementation of any of the time periods shown. However, if total execution time is to be decreased, then the optimization of some services may be less effective than others.

For example, optimizing the services involved with side paths 1022-1023 is unlikely to boost total throughput. Whereas, the path of the longest duration may be a critical path.

As such, optimizing any of the services involved with time periods 1011-1013 within critical path 1021 may better decrease total latency. Critical path 1021 may have its own correlation identifier for trace isolation.

Another optimization heuristic is to optimize the service of the long pole, which is the longest individual time period within the critical path, regardless of whether or not that particular time period overlaps (is concurrent) with other time periods. For example as the long pole, time period 1012 may be the best candidate for optimization, even though Amdahl's Law favors optimizing time periods 1011 and 1013 which have gray-colored segments that are serial, per legend 1001.

### Trace Simulation

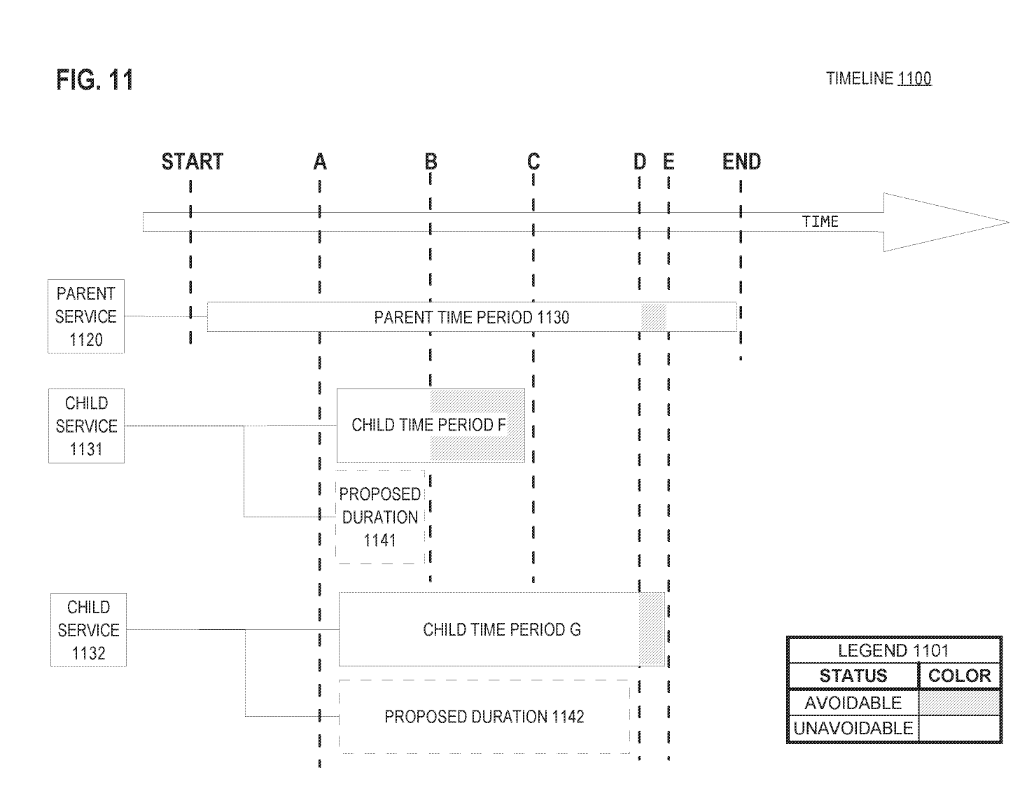

FIG. 11 is a block diagram that depicts example timeline 1100 as an observed schedule of executed service calls, in an embodiment. A computer may analyze the elements of timeline 1100 to quantify a benefit of a hypothetical optimization of a service implementation, in an embodiment.

Timeline 1100 shows child time periods F-G spent by calls to child services 1131-1132 that are invoked by parent service 1120 during parent time period 1130. Timestamp data for time periods 1130 and F-G are warehoused in a file system or database for later analysis, including simulation.

Trace simulation is a speculative way to discover, perhaps by trial and error, potential optimizations that could decrease total latency. In other words, a goal of trace simulation is to identify optimizations that may decrease the total duration between time START and time END.

Trace simulation occurs by choosing a time period and evaluating whether a hypothetical optimization that achieves a particular decrease in execution time would have the intended effect of decreasing total latency. For example, a software developer may wonder whether total latency may be decreased by a hypothetical optimization that decreases child time period F by eliminating (optimizing away) the gray-colored segment of child time period F that spans from time B to time C.

Per legend 1101, gray indicates a segment that is potentially avoidable or otherwise optimizable. Eliminating the gray-colored segment of child time period F would effectively decrease time period F to become as short as proposed duration 1141.

As such, the developer or automation may simulate with proposed duration 1141 to detect whether that is enough of an optimization to decrease total latency. However, simulation would reveal that proposed duration 1141 will not decrease total latency.

This is because either of parent time period 1130 and child time period G still occupy the region of timeline 100 that would be optimized away (i.e. the eliminated gray segment between time B and time C) from child time period F. That is, a latency spanning from time B to time C remains, despite proposed duration 1141.

Likewise, simulating the replacement of child time period G with proposed duration 1142 may or may not decrease total latency. For example, if the gray segment of parent time period 1130 indicates that parent service 1120 is blocked while waiting for child server 1132 to finish, then proposed duration 1142 may provide a decrease in overall latency.

However, if the gray segment of parent time period 1130 indicates that parent service 1120 continues its own processing concurrent to child service 1132, then proposed duration 1142 by itself is insufficient to achieve a decrease in overall latency. In such a case, only if the gray segments of both of time periods 1130 and G were optimized away, then simulation would reveal a decrease of total latency.

That is, although timeline 1100 has three avoidable (gray) segments that may individually be optimized away, no one of these optimizations individually will decrease the total latency. Only optimizing away both gray segments that occupy the duration between time D and time E will decrease total latency.

In practice, analysis of the time periods shown along timeline 1100 may not yield reliable insights. This is because time periods may have statistical variations between similar invocations of a same service.

To achieve statistical reliability, many similar invocations may need to have their execution times averaged together. Averaging may reveal idealized timing information for invocations of services. Averaging is discussed in detail later herein.

### Example Trace Simulation Process

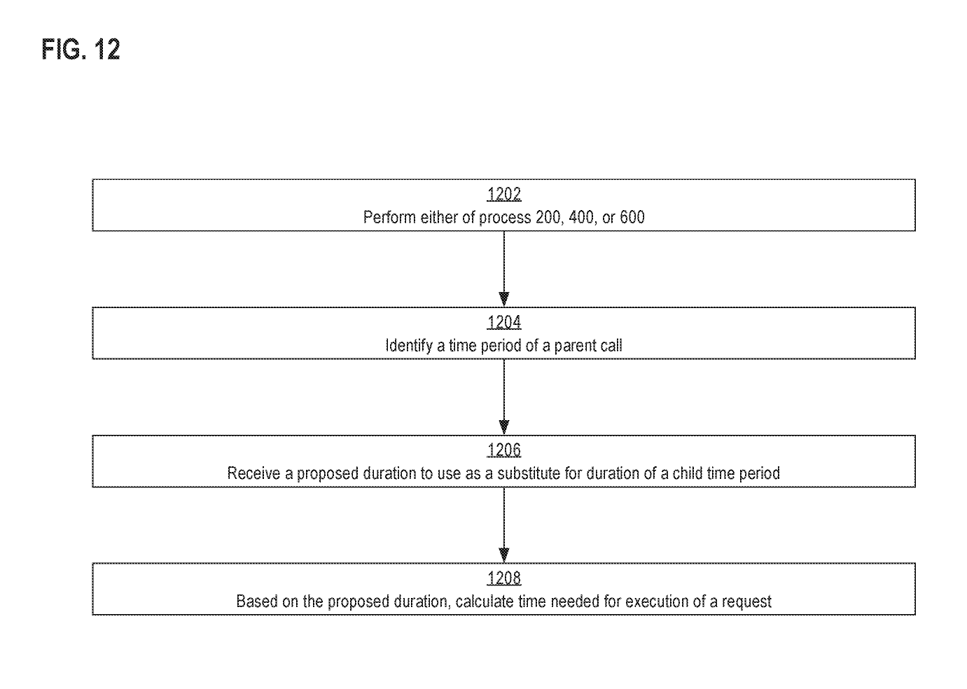

FIG. 12 is a flowchart that depicts an example process for trace simulation. This process is discussed with reference to timeline 1100.

Trace simulation incorporates mechanisms already discussed herein. For example this may include all or at least much of a process discussed herein such as 200, 400, or 600.

In step 1202, the time periods for calls of an execution trace are accounted, perhaps with apportionment. For example, a computer performs process 200, 400, or 600.

In step 1204, the time period of a parent call within the trace is identified. For example, the computer selects parent time period 1130. Alternatively, the computer may select the time period of a root request.

In step 1206, a proposed duration to use as a substitute for the duration of a child time period is received. For example, a software developer enters proposed duration 1141 into the computer, perhaps via a graphical user interface (GUI). Alternatively, proposed duration 1141 is generated or otherwise obtained from an automated source.

In step 1208, based on the proposed duration, the time needed for execution of the request is calculated. For example, the computer performs accounting and perhaps apportionment using proposed duration 1141 instead of child time period F to calculate total latency.

### Trace Averaging

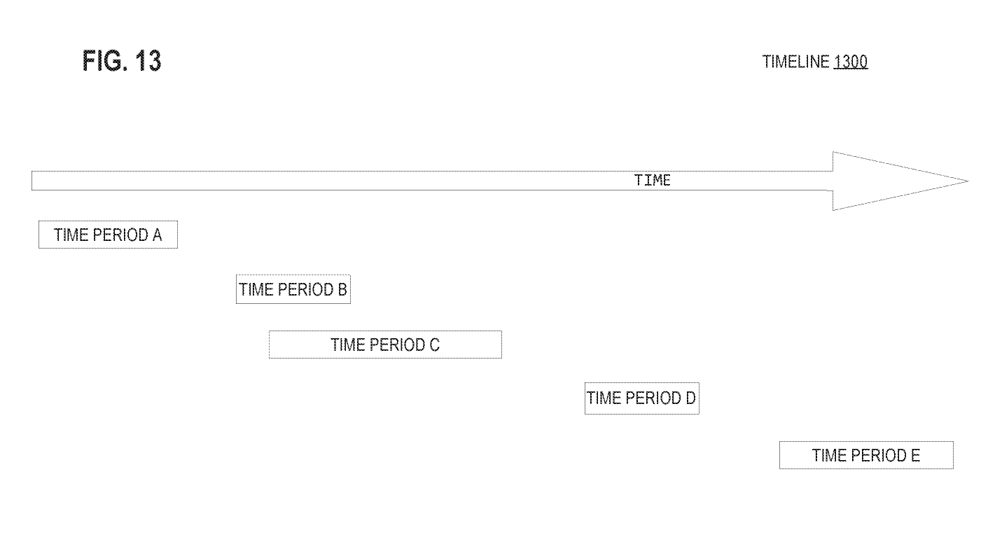

FIG. 13 is a block diagram that depicts example timeline 1300 as an observed schedule of executed service calls, in an embodiment. A computer may analyze the elements of timeline 1300 to smooth over variations between different invocations of a same service, in an embodiment.

Timeline 1300 shows time periods A-E, which are different invocations of a same service, perhaps for different root requests. Time periods for service execution are naturally variable because of fluctuating factors such as clock skew, the computational load of a computer or cluster, network congestion, and other resource contention.

Time periods A-E do not have identical durations despite them being for executions of the same service. Variation may be problematic, because optimization may depend on concepts such as serial, overlap, critical path, and long pole.

However, all of these concepts are prone to inaccuracy because of variations in service execution duration, especially when anecdotally selecting a particular trace. Hence, a need arises for averaging of service execution durations.

For example, timestamp data for time periods A-E may be warehoused in a file system or database for later analysis, including simulation. Data mining of timestamp data of multiple traces, requests, call graphs, or calls may increase the confidence of optimization proposals, perhaps during simulation.

In an embodiment, an ideal theoretical trace is synthesized by averaging service time periods of multiple similar actual traces. For example, traces of a same parent service or root request may be averaged. Likewise, timestamp data of multiple invocations of a same service may be averaged without trace data of its parent service and its child services.

Synthesizing an idealized execution time of a service may involving averaging hundreds or thousands of invocation time periods for that service. In a related embodiment, a certain percentile (e.g., 90% or median) of service time periods is determined.

Averaging may also be combined with simulation. For example, a proposed optimized (decreased) duration of a service duration may affect the duration of many or all invocations of the service.

Simulation may analyze a proposed optimization based on multiple requests, rather than a single request in isolation. For example, one proposed optimization may accelerate many call trees of many requests.

A simulation of a single call graph may involve recalculating the total time for the whole graph or some part of it due to the optimization. Likewise, simulation that covers many call graphs may involve recalculating many call graphs to determine an average benefit of the proposed optimization. As such, simulation combined with averaging may more accurately predict an effect of a proposed optimization, based on the optimization decreasing the duration of each of many invocations.

Recalculating many call graphs may more accurately account for boundary conditions and limits that may determine the effect on the optimization within a given call graph. This may also apply to repeated simulations with various optimized durations for a same service. For example, simulating with many call graphs may reveal that, although a 10% optimization of a service yields a 3% improvement to average request time, a better optimization such as 15% may be revealed during simulation as not yielding better results to average request time.

### Example Trace Averaging Process

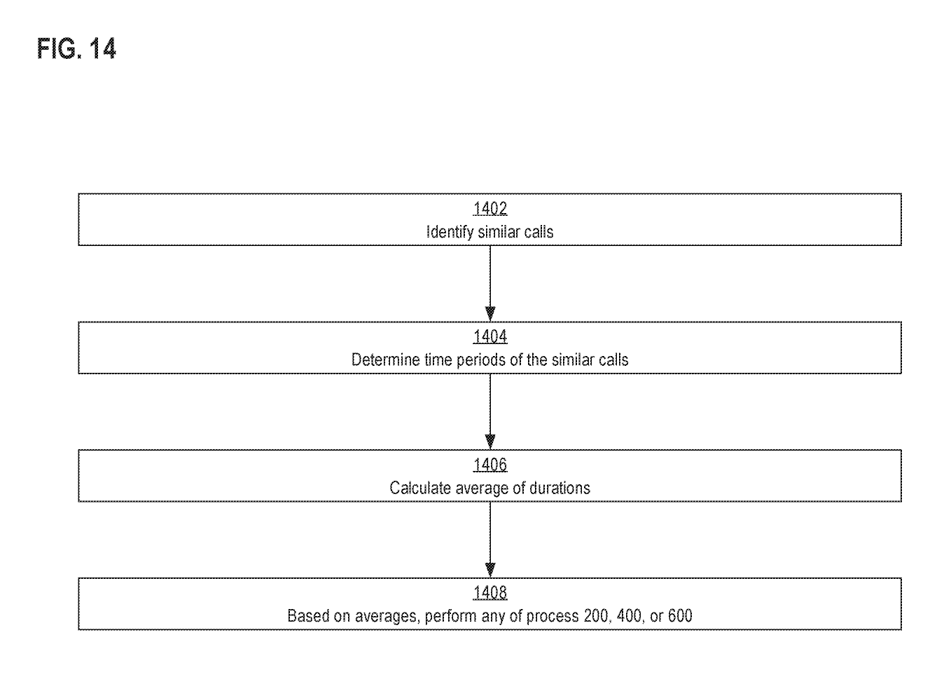

FIG. 14 is a flowchart that depicts an example process for trace averaging. This process is discussed with reference to timeline 1300.

Trace averaging incorporates mechanisms already discussed herein. For example this may include at least a portion of a process discussed herein such as 200, 400, or 600.

In step 1402, similar calls are identified for averaging. For example, a computer selects time periods A-E because they are for calls to a same service. For example, a software developer seeks an idealized duration to characterize the execution latency of the service.

In step 1404, the time periods of the similar calls are determined. For example, the computer retrieves the time stamp data time periods A-E of the similar calls.

In step 1406, averages of durations are calculated. For example, the computer analyzes time periods A-E to calculate their durations. The computer may also calculate the durations of gaps that separate the end of one time period from the start of another time period. The computer may also calculate the durations of overlaps between time periods. Such additional calculations may provide further insight into the value of optimizing an implementation for a given service call.

In step 1408, the time period averages for calls of an execution trace are accounted, perhaps with apportionment. For example, a computer performs process 200, 400, or 600 upon a synthesized ideal trace that is based on time period averages.

### Web Browser Tracing

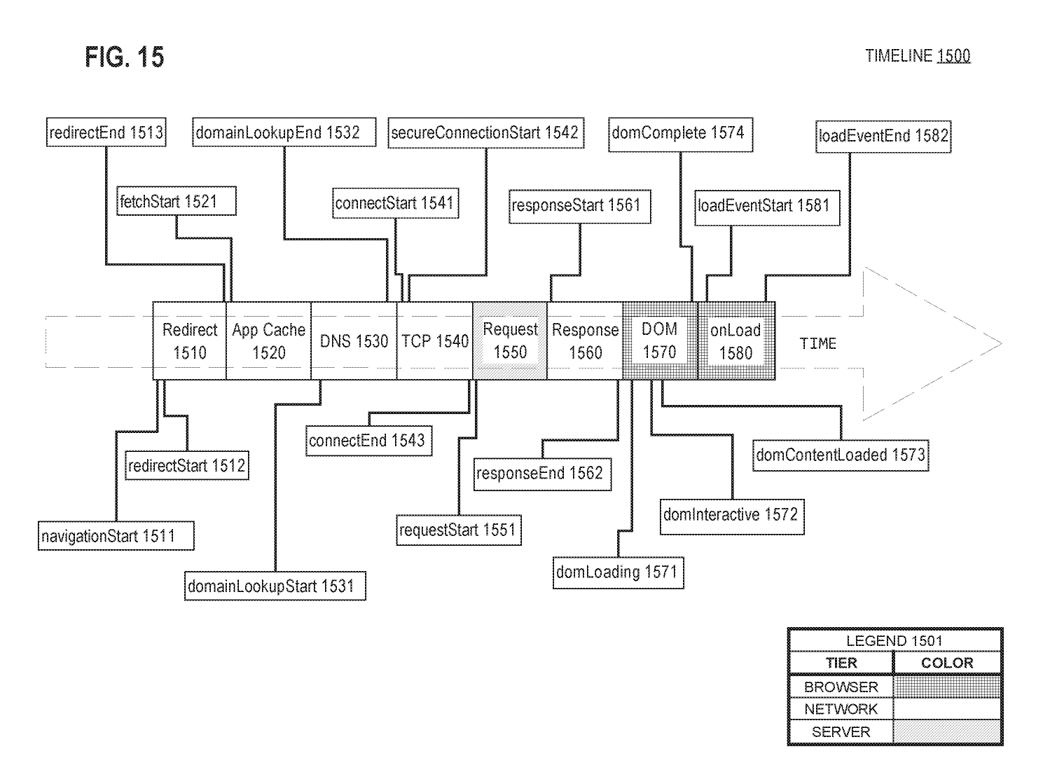

FIG. 15 is a block diagram that depicts example timeline 1500 as an observed schedule of executed service calls, in an embodiment. A computer may analyze the elements of timeline 1500 to perform accounting, apportionment, or simulation, in an embodiment.

Timeline 1500 shows child time periods F-G spent by calls to child services 1510, 1520, 1530, 1540, 1550, 1560, 1570, and 1580 that correspond to phases of the processing model of the navigation timing recommendation of the world wide web consortium (W3C). In other words, these child services correspond to the phases that occur during web page loading by a web browser.

A web browser may natively, by browser plugin or by JavaScript, measure and store or send timestamp data for the executions of these phases during page loading. The web browser may also measure timestamp data for other services that are invoked by these services, such as the loading of images and other page resources that perhaps occur concurrently.

A computer may analyze these timestamp data to isolate a page loading bottleneck. Once isolated, a topological tier may be identified as a source of the bottleneck.

For example, the topological tiers are listed in the left column of legend 1501. Most of the phases are white-colored, which suggests that network latency presents the most opportunities for bottlenecks.

However, the phases 1550, 1570, and 1580 have other colors. The cross-hatch color of phases 1570 and 1580 indicate opportunities for a bottleneck within the browser itself, such as within JavaScript. The striped color of phase 1550 indicates opportunities for a bottleneck on the web server that generates the web page being loaded.

Finer isolation of a bottleneck is possible with timestamps for particular services that are invoked during a particular phase. For example, phase 1570 sequentially calls services 1571-1574. Although these service calls occur within the context of standardized lifecycle events, their implementations as event handlers are nonetheless services.

Some of these particular services are especially meaningful. For example, DNS 1530, connectStart 1541, and requestStart 1551 mark significant moments during page loading that may increase visibility into the performance effects of the tiers that interface with the browser. For example, responseStart 1561 and responseEnd 1562 respectively represents receipt at the browser of the first or last byte from the server.

Although timeline 1500 shows only calls that may be measured by the browser, other calls not shown may occur during execution of a request, such as an HTTP request, within the network or server tiers that must be measured within those tiers and not by the browser. In an embodiment, a call trace is composed of timestamp data measured by more than one tier.

For example, a cache for a content distribution network (CDN) may reside within either the network or server tier. Trace data that spans multiple tiers may be used to determine whether the CDN is a bottleneck or not.

Browsing is not the only use of HTTP, and some of the phases of timeline 1500 are applicable to other client/server uses of web resources. For example, computer programs may use HTTP to exchange simple object access protocol (SOAP) calls. A web embodiment need not be limited to HTTP because other protocol standards are available, such as file transfer protocol (FTP).

Likewise the uniform resource locator (URL) of a web page is not the only way address a web resource. For example an HTTP request or other request may use some other type of uniform resource identifier (URI) such as a uniform resource name (URN).

### Graphical User Interface

The techniques described above may be accompanied by a graphical user interface to boost comprehension, by a user, of the constraints and factors discussed above. FIGS. 1, 3, 5, 7-11, 13, and 15 may represent screen snapshots of the graphical user interface. The rendered features of these screens may be interactive. For example, each traced invocation may be expanded or collapsed to reveal or hide subordinate invocations of other services that were caused by a rendered invocation. Timing numbers may be directly rendered or shown in response to certain interactions or contexts. Embedding within an integrated development environment (IDE) or similar computer-aided software engineering (CASE) tool may enable seamless navigation between timeline diagrams and source logic.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

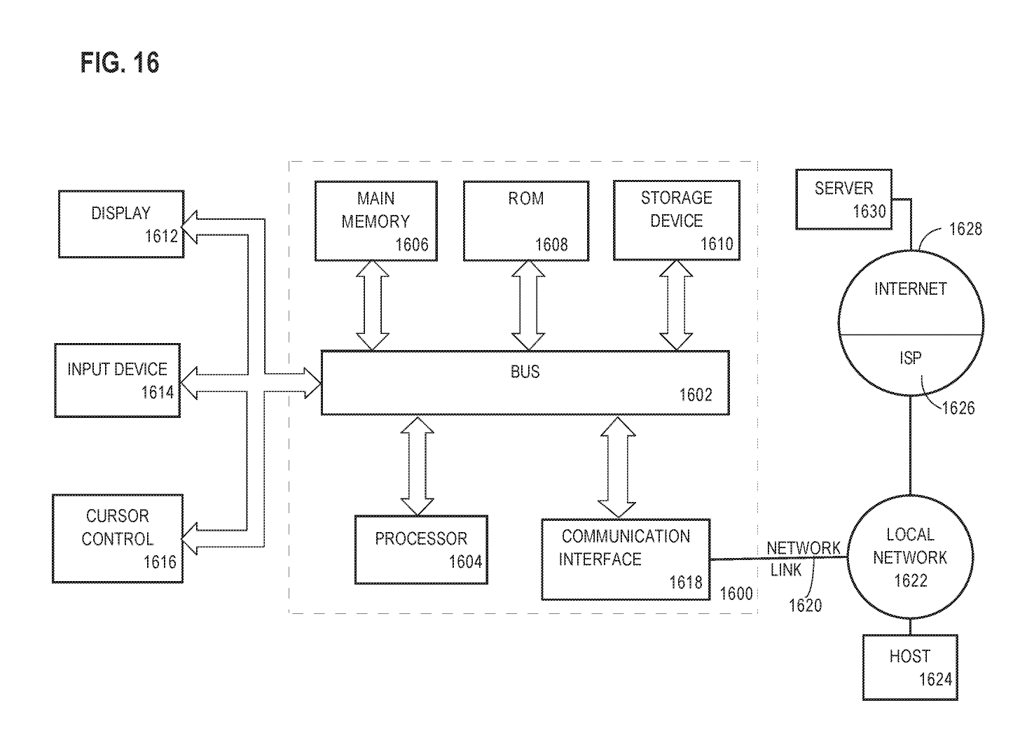

For example, FIG. 16 is a block diagram that illustrates a computer system 1600 upon which an embodiment of the invention may be implemented. Computer system 1600 includes a bus 1602 or other communication mechanism for communicating information, and a hardware processor 1604 coupled with bus 1602 for processing information. Hardware processor 1604 may be, for example, a general purpose microprocessor.

Computer system 1600 also includes a main memory 1606, such as a random access memory (RAM) or other dynamic storage device, coupled to bus 1602 for storing information and instructions to be executed by processor 1604. Main memory 1606 also may be used for storing temporary variables or other intermediate information during execution of instructions to be executed by processor 1604. Such instructions, when stored in non-transitory storage media accessible to processor 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a cathode ray tube (CRT), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

Computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor 1604 executing one or more sequences of one or more instructions contained in main memory 1606. Such instructions may be read into main memory 1606 from another storage medium, such as storage device 1610. Execution of the sequences of instructions contained in main memory 1606 causes processor 1604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1610. Volatile media includes dynamic memory, such as main memory 1606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1602. Transmission media can also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of transmission media.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618.

The received code may be executed by processor 1604 as it is received, and/or stored in storage device 1610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing timestamp data that indicates, for each call of a plurality of calls made during processing of a particular request, at least two of: a duration, a starting timestamp, and an ending timestamp;
identifying, based on the timestamp data associated with a first call of the plurality of calls, a first time period for the first call;
identifying, based on the timestamp data associated with a second call of the plurality of calls, a second time period for the second call;
determining that the first time period overlaps the second time period;
based on an overlap amount of time that the first time period overlaps the second time period:
calculating a first amount of processing for the first call, wherein the first amount is based on said overlap amount;
calculating a second amount of processing for the second call, wherein the second amount is based on said overlap amount;
wherein the method is performed by one or more computing devices.

2. The method of claim 1 wherein calculating the first amount comprises calculating the first amount and the second amount based on a same particular fraction of said overlap amount.

3. The method of claim 1 wherein the first amount is further based on a portion, of the first time period, that does not overlap the second time period.

4. The method of claim 1 wherein at least one call of the plurality of calls comprises at least one of: a subroutine invocation, a remote service invocation, a query such as a database query, a resource retrieval request such as a retrieval of an online object, a dispatch of a message, a dispatch or interpretation of a command, or a program execution.

5. The method of claim 1 wherein said particular request comprises a universal resource identifier (URI).

6. The method of claim 1 further comprising:
measuring, by a first computer, the timestamp data associated with the first call; and
measuring, by a second computer, the timestamp data associated with the second call.

7. The method of claim 1 further comprising measuring by a web browser the timestamp data associated with the first call.

8. The method of claim 7 wherein the timestamp data of the first call comprises a timestamp associated with at least one of: sending said particular request, establishing a network connection, domain name service (DNS) usage, receiving a first byte of a response for said particular request, receiving a last byte of a response for said particular request.

9. The method of claim 1 further comprising determining whether the first call is part of a critical path of an execution of said particular request.

10. The method of claim 1 further comprising:
identifying a third time period of a third call of the plurality of calls, wherein the third time period contains the first time period and the second time period;
receiving a proposed duration to use as a substitute for the duration of the first time period, wherein the proposed duration is less than the duration of the first time period; and
calculating, based on the proposed duration, a time needed for an execution of said particular request.

11. The method of claim 1 further comprising using an identifier to associate any two of:
said particular request, the first call, the timestamp data associated with the first call, or a call graph that comprises the plurality of calls.

12. The method of claim 1 performed separately for each of a plurality of requests for a same service or a same resource, to associate the plurality of requests with a plurality of calls made during processing of the plurality of requests, wherein the method further comprises:
identifying a plurality of similar calls, wherein each of the plurality of similar calls was made during processing of a different request;
calculating, based on said plurality of similar calls, a plurality of durations; and
calculating the average of said plurality of durations.

13. One or more non-transitory computer-readable media comprising instructions that when executed by one or more processors cause:
storing timestamp data that indicates, for each call of a plurality of calls made during processing of a particular request, at least two of: a duration, a starting timestamp, and an ending timestamp;
identifying, based on the timestamp data associated with a first call of the plurality of calls, a first time period for the first call;
identifying, based on the timestamp data associated with a second call of the plurality of calls, a second time period for the second call;
determining that the first time period overlaps the second time period;
based on an overlap amount of time that the first time period overlaps the second time period:
calculating a first amount of processing for the first call, wherein the first amount is based on said overlap amount;
calculating a second amount of processing for the second call, wherein the second amount is based on said overlap amount.

14. The computer-readable media of claim 13 wherein the first amount is further based on a portion, of the first time period, that does not overlap the second time period.

15. The computer-readable media of claim 13 wherein at least one call of the plurality of calls comprises at least one of: a subroutine invocation, a remote service invocation, a query such as a database query, a resource retrieval request such as a retrieval of an online object, a dispatch of a message, a dispatch or interpretation of a command, or a program execution.

16. The computer-readable media of claim 13 wherein the instructions further cause measuring by a web browser the timestamp data associated with the first call.

17. The computer-readable media of claim 16 wherein the timestamp data of the first call comprises a timestamp associated with at least one of: sending said particular request, establishing a network connection, domain name service (DNS) usage, receiving a first byte of a response for said particular request, receiving a last byte of a response for said particular request.

18. The computer-readable media of claim 13 wherein the instructions further cause:
identifying a third time period of a third call of the plurality of calls, wherein the third time period contains the first time period and the second time period;
receiving a proposed duration to use as a substitute for the duration of the first time period, wherein the proposed duration is less than the duration of the first time period; and
calculating, based on the proposed duration, a time needed for the execution of said particular request.

19. A method comprising:
determining a total amount of time to process a request;
determining that a plurality of services are called in order to process the request, wherein the plurality of services includes a first service and a second service;
determining a first amount of time that the first service spends in response to processing the request;
determining a second amount of time that the second service spends in response to processing the request;
calculating a first percentage for the first service based on the first amount of time and the total amount of time;
calculating a second percentage for the second service based on the second amount of time and the total amount of time;
wherein the method is performed by one or more computing devices.

20. A method comprising:
determining a first amount of time that a first service, of a plurality of services, takes to respond to a call to the first service;
determining that, in response to the call, the first service makes one or more subsequent calls to one or more other services;
for each service of the one or more other services, determining a second amount of time that the first service waits to respond to one of the one or more subsequent calls;
calculating a latency of the first service based on the first amount of time and the second amount of time that are associated with each service of the one or more other services.
